(19) United States
(12) Patent Application Publication
(10) Pub. No.: US 2026/0358113 A1
(43) Pub. Date: Nov. 12, 2026

(54) REFLECTIVE INTERFEROMETER SYSTEMS AND METHODS THEREOF

(71) Applicant: Munro Design & Technologies, LLC, Ontario, NY (US)

(72) Inventors: Samuel J. POWERS, Rochester, NY (US); James F. Munro, Ontario, NY (US)

(21) Appl. No.: 19/668,421

(22) Filed: May 5, 2026

Related U.S. Application Data
(60) Provisional application No. 63/800,905, filed on May 6, 2025.

(51) Int. Cl. G01B 9/02055; G01B 11/14

(52) U.S. Cl. CPC G01B 9/02075; G01B 11/14

(57) ABSTRACT

An all-reflective optical interferometer system for measuring the displacement of a location of a measurement surface includes a fiber optic, a first parabolic collimator for collimating light exiting from the fiber and for focusing collimated light into the fiber, a beamsplitter having an aperture, a second parabolic collimator for focusing collimated light onto a measurement surface and for collimating light back-reflected from the measurement surface, and a reference arm. The optical interferometer system may also include a calibration arm provided with a multi-element photodetector whose output is used as an indicator of the amount and direction of tilt of the measurement surface so that systemic errors of the interferometer induced by the tilt of the measurement surface can be determined and removed from the displacement measurement.

This application claims priority of U.S. Provisional Application Ser. No. 63/800,905, filed May 6, 2025, which is hereby incorporated by reference in its entirety

### FIELD

This technology generally relates to systems and methods for interferometrically measuring the displacement of a surface with high accuracy even when the surface is sloped or tilted.

### BACKGROUND

Areal surface interferometry, including areal phase-measuring interferometry, has been used to measure the shape or form of optical surfaces for several decades. While generally quite fast, prior areal interferometry systems suffer from uncorrectable errors, such as retrace errors, that place a limit on their ultimate accuracy.

Areal interferometers often depend on test spheres and null correctors, and an error in their fabrication can result in later errors in the surface topography measurement results. In this example, the infamous surface errors in the primary mirror of the Hubble Space Telescope have been traced to problems with a null corrector. Since that time NASA—and associated manufacturers of large optics—have been seeking non-areal yet non-contact approaches for high-precision surface metrology. Generally, these approaches have entailed the use of an optical probe system that measures displacement of a surface at a given location, and the probe is then scanned across the surface of interest to generate a complete surface profile.

One such prior art displacement measuring device is the spectral interferometric probe 10 shown in FIG. 1. The spectral interferometric probe 10 has a broadband light source 12 that emits light that is subsequently collimated by collimating lens 14 which then enters a beamsplitter 16. The beamsplitter 16 reflects a portion of the collimated light beam causing a portion of said collimated light beam to enter a chromatic lens 28 that focuses the light in such a way that its focal position along an optical axis 18 varies with wavelength. This converging chromatic light then strikes a second beamsplitter 30 which further divides the beam into a reference beam, shown reflecting to the left in FIG. 1 towards a reference mirror 24, and a measurement beam shown propagating downward through the second beamsplitter 30 towards a measurement surface 32. Note that the chromatic lens 28, the second beamsplitter 30, and the reference mirror 24 are located within the measurement head 20, which in turn is coupled to a linear piezo-electric transducer stage 22. The linear piezo-electric transducer stage 22 can cause the measurement head 20, and its internal constituents, to move along the optical axis 18 closer to or further away from the measurement surface 32. Light reflected from the reference mirror 24 and the measurement surface 32 (at measurement spot 26) both reflect back to the second beamsplitter 30 and then both re-enter the chromatic lens 28 which then re-collimates the two light beams.

The two re-collimated light beams then pass through the beamsplitter 16, enter the focusing lens 40, and then enter the spectrograph 42 through a small aperture at the focal point of the focusing lens 40. The two re-collimated beams then form a spectral interference pattern on the image sensor of the camera 44 associated with the spectrograph 42. The resulting spectral interference fringe pattern has several inflection points and high-slope regions for improved downstream processing and fitting by the digital processor 46.

Under these conditions, the displacement can be found quite accurately, to less than a nanometer, and is a particular strength of the spectral interferometric probe 10. A second strength is that if the measurement light reflected from the measurement surface 32 is weak (perhaps because the measurement surface 32 is highly polished and tilted) then the interferometric gain present in the interference pattern provides a means of intensifying the weak optical signal so that it is of sufficient brightness to be image-able by the spectrograph 42 and to be processed by the digital processor 46.

Unfortunately, a serious drawback of the spectral interferometric probe 10 is that the optical path lengths of the reference arm and the measurement arm in this example are substantially equal in order to obtain interference fringes at the image sensor of the camera 44. Since the optical path length, or equivalently the displacement, associated with the measurement surface 32 is unknown, then the position of the reference mirror 24 in this example is scanned, or equivalently, the reference arm is not scanned and instead the whole measurement head 20 is scanned by virtue of PZT 22 until a scanning position is found that produces the desired interference fringes. This scanning process requires a significant amount of time and limits the measurement throughput rate of spectral interferometer probe 10 to about 100 displacement measurement per second.

### SUMMARY

An interferometer includes a measurement arm, a reference arm, a calibration arm, an input/output arm, and a reflective beamsplitter that couples light between the various arms of the interferometer. The input/output arm comprises a fiber optic that couples light from a broadband laser into the interferometer and a first parabolic mirror that collimates the diverging light exiting the fiber and directs that collimated light towards the beamsplitter. The first parabolic mirror also focuses collimated output light from the beamsplitter into the fiber optic which then transmits the output light to a spectrometer where spectral fringes are produced and processed by a downstream digital processor. The reference arm comprises a substantially planar reference mirror that reflects back to the beamsplitter that light that was reflected to it from the beamsplitter. The measurement arm comprises a second reflective parabolic collimator that causes the collimated light incident on it from the beamsplitter to be focused onto a measurement surface; the second reflective parabolic collimator also collimates the diverging light incident upon it that was reflected from the measurement surface and directs that collimated light back towards the beamsplitter. The calibration arm comprises an optical detector, such as a digital camera, which receives light from the beamsplitter directed to it from the measurement arm and in which the image captured by the digital camera is processed to determine a tilt or slope of the measurement surface.

The beamsplitter is a reflective right-angle prism configured to receive substantially collimated light from the input/output arm and reflect a portion of that light into the reference arm. A substantially planar reference mirror within the reference arm reflects the reference light back to the beamsplitter where it is reflected back to the first reflective collimator which then focuses the reference light onto the input/output fiber optic. A light-transmitting thru-hole or aperture in the beamsplitter allows a substantial portion of the collimated light received from the first reflective parabolic collimator to be transmitted into the measurement arm whereby the second parabolic collimator focuses the collimated light that passes through beamsplitter onto the measurement surface. Light that is reflected back from the measurement surface is re-collimated by the second reflective parabolic collimator which directs the collimated light back to the beamsplitter. If the surface is substantially without tilt or slope then the collimated measurement light substantially passes back through the beamsplitter aperture to the first reflective collimator which then focuses the light onto the input/output fiber. If the measurement surface has an amount of tilt or slope then a portion of the collimated measurement light from the second reflective collimator will miss the beamsplitter's aperture and will be reflected from the beamsplitter into the calibration arm whereupon the light will be incident upon an image sensor whose output electronic image is processed to determine the amount and direction of measurement surface slope such that slope-induced measurement errors can be subsequently subtracted from a measurement made by the interferometer.

Reference and measurement light that is incident on the input/output fiber optic of the input/output arm are transmitted by the fiber optic to a spectrograph whose output spectral interferogram is captured and digitized by a digital camera and subsequently processed by a digital processing system which is configured to determine at least one measured property, such as displacement, of the measurement surface from the detected measurement light and the detected reference light.

An optical interferometer system comprising a first parabolic collimator, a beamsplitter, and a second parabolic collimator. The first parabolic collimator is configured to substantially collimate input light on to a collimated light axis. The beamsplitter is configured to split the collimated input light on the collimated light axis into a collimated reference arm light substantially centered on a reference arm axis and collimated measurement arm light substantially centered on the collimated light axis. The second parabolic collimator is configured to substantially focus the collimated measurement light centered on the collimated light axis along a measurement arm axis onto a measurement surface and to substantially collimate at least a portion of the collimated measurement light reflected back from the measurement surface. The beamsplitter is configured to recombine the collimated reference arm light reflected from a reference mirror and the collimated measurement light reflected back from the measurement surface and direct the recombined light towards the first parabolic collimator. The first parabolic collimator is configured to output the recombined light comprising a measurement of the measurement surface.

A method for making an optical interferometer system includes providing a first parabolic collimator configured to substantially collimate input light on to a collimated light axis. A beamsplitter is positioned to split the collimated input light on the collimated light axis into a collimated reference arm light substantially centered on a reference arm axis and collimated measurement arm light substantially centered on the collimated light axis. A second parabolic collimator is positioned to substantially focus the collimated measurement light centered on the collimated light axis along a measurement arm axis onto a measurement surface and to substantially collimate at least a portion of the collimated measurement light reflected back from the measurement surface. The beamsplitter is configured to recombine the collimated reference arm light reflected from a reference mirror and the collimated measurement light reflected back from the measurement surface and direct the recombined light towards the first parabolic collimator. The first parabolic collimator is configured to output the recombined light comprising a measurement of the measurement surface.

Accordingly, examples of the claimed technology provide a number of advantages including measurement operations that do not require the mechanical movement of a reference mirror or an interferometer head to perform a displacement measurement such that the measurement system has a fast displacement measurement rate, as well as the high accuracy of an interferometric probe even when the surface being measured is sloped or tilted.

### BRIEF DESCRIPTION OF THE DRAWINGS

FIG. 1 is a block diagram of a prior art confocal interferometric displacement measuring system;

FIG. 2 is a block diagram of an example of an interferometer system in accordance with examples of this technology;

FIG. 3 is a plan-view diagram of an example of an interferometer of the interferometer system shown in FIG. 2;

FIG. 4 is a block diagram of an example of an interferometer system that includes a calibration arm in accordance with examples of this technology;

FIG. 5 is a plan-view diagram of a second example of an interferometer of the interferometer system shown in FIG. 4 in which the measurement surface is orthogonal to the measurement axis;

FIG. 6 is a plan-view diagram of a second example of an interferometer of the interferometer system shown in FIG. 4 in which the measurement surface is not orthogonal to the measurement axis;

FIG. 7A is an image of the light incident on an image sensor of the calibration arm of the interferometer shown in FIG. 5 in which the measured surface is orthogonal to the measurement axis;

FIG. 7B is an image of the light incident on an image sensor of the calibration arm of the interferometer shown in FIG. 6 in which the measurement surface is not orthogonal to the measurement axis; and

FIG. 8 is an image of the spectral interferogram output by a spectrograph in accordance with examples of this technology.

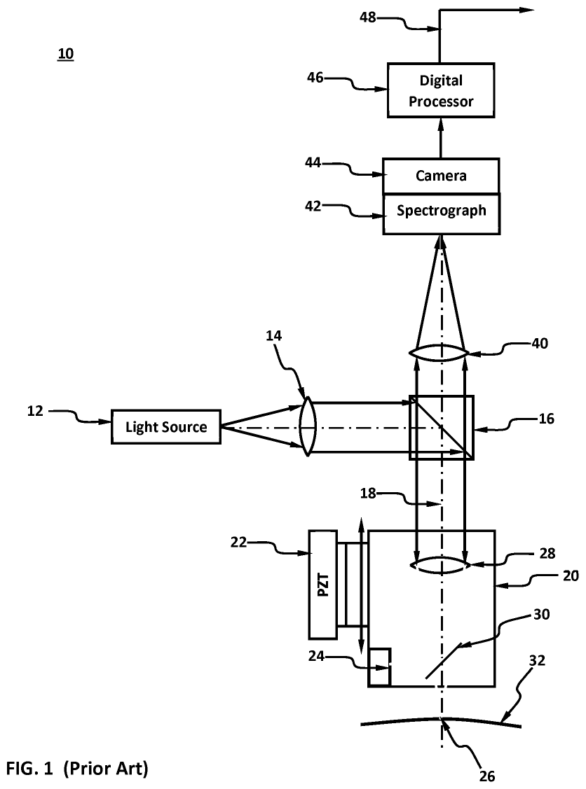

### DETAILED DESCRIPTION

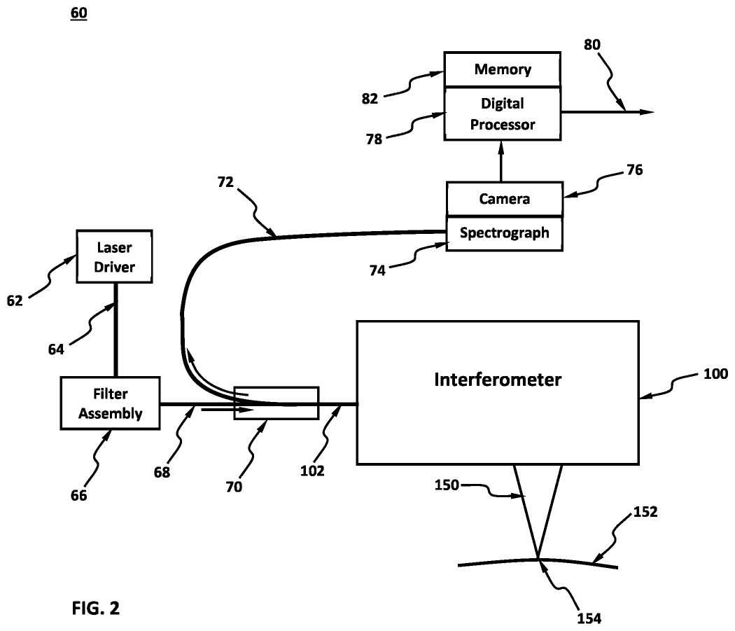

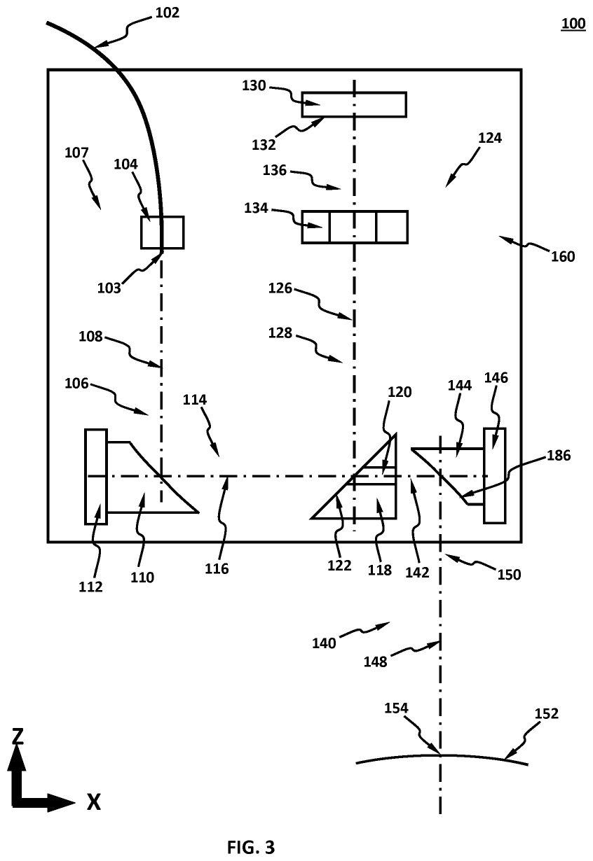

An interferometer system 60 in accordance with examples of the claimed technology is illustrated in FIG. 2 and FIG. 3. In this example, the interferometer system 60 comprises a laser driver 62, a broad-band fiber laser 64, a filter assembly 66, a source fiber optic 68, a fiber coupler 70, an input/output fiber 102 having an aperture 103, an interferometer 100, an output fiber 72, a spectrograph 74, a camera 76, a digital processing system 78 with memory 82, and an interferometer system output 80, although the interferometer system 60 may have other types and/or numbers of other components and/or other elements in other configurations. Interferometer 100 comprises a base 160, fiber mount 104, first parabolic collimator 110 having a first parabolic collimator mount 112, beamsplitter 118, reference mirror 130, iris 134, a second parabolic collimator 144 having parabolic surface 186 and associated second parabolic collimator mount 146 as shown in FIG. 3, although alternate interferometer configurations and other components are possible as well. The claimed technology provides a number of advantages including providing a displacement measurement system that has a fast displacement measurement rate and high accuracy.

Referring more specifically to FIG. 2, the laser driver 62 has an output coupled to a fiber laser 64 whose light output is coupled to an input of filter assembly 66, although other components and/or elements in other configurations may be used. The laser driver 62 and the fiber laser 64 together comprise a broadband light source, whose output is through a small-diameter aperture at the end of fiber laser 64, although other types of light sources may be used. In one example, the laser driver 62 and the fiber laser 64 are a so-called white-light laser, more technically known as a supercontinuum laser, although other types of white light or other broadband light sources, such as those that utilize LEDs, SLEDs (super-luminescent LEDs) or incandescence by way of example, can be used.

In this example, the requirements and characteristics of the light source are: (1) that the output light pass through a small-diameter aperture such as a 5 μm diameter associated with a single-mode fiber; (2) that as much optical flux passes through the output aperture as possible; (3) that the coherence length of the light is greater than or equal to 1 mm, and (4) that the output photon flux is broad-band, although other types and/or numbers of requirements and/or characteristics of the light source may be used in other examples. For example, typically the fiber laser 64 is a single-mode fiber and has a core diameter—and exit aperture diameter—of less than 10 μm, and in some examples preferably less than or equal to 5 μm. The optical flux exiting the fiber laser 64 in this example should be as great as possible, being at least 100 μW/nm, or in some examples advantageously at least 200 μW/nm, or in other examples advantageously greater than 1 mW/nm. Finally, in this example the spectrum of the light exiting the light source is broadband, and also of a wavelength range that the downstream image sensor of camera 76 is responsive to. In particular, in this example light in the range of 500 nm to 700 nm is advantageous, while light from 450 nm to 800 nm is even more advantageous, although in other examples other ranges in some examples may be preferred such as from 800 nm to 2400 nm.

One of ordinary skill in the art will appreciate that the laws of etendue generally restrict the ability of a light source to output relatively large spectral flux values. However, in this example a laser driver 62 and a fiber laser 64 comprising a supercontinuum laser can economically meet the desired flux emission values with a small (e.g., 5 μm diameter) aperture as well as the desired wavelength range. A supercontinuum laser often produces significant amounts of light above 800 nm, and because these wavelengths of light are generally not needed or used by examples of the claimed technology, and if not removed can propagate into interferometer 100 or interferometer 200 and be absorbed by components or surfaces inside interferometer 100 or interferometer 200 thereby generating heat and internal thermal gradients. Since these internal thermal gradients can cause poor displacement measuring performance, it is desirable to filter these longer wavelengths or otherwise prevent them from entering interferometer 100 or interferometer 200.

The filter assembly 66 has an input coupled to an output of the fiber laser 64 and an output coupled to a source fiber 68, although other components and/or elements in other configurations may be used. The filter assembly 66 has provisions for filtering the unwanted wavelengths from the light output from fiber laser 64, such as wavelengths greater than 800 nm or wavelengths less than 450 nm, although other types of filters may be used. In other examples, the filter assembly 66 may also have provisions for filtering unwanted polarizations from the light output from the fiber laser 64 and for ensuring that the polarization passing through the filter assembly 66 and into the source fiber 68 is of a known polarization state and orientation, although the filter assembly may have other types and/or numbers of provisions.

The source fiber 68 is used to couple the filtered light output by the filter assembly 66 to an input of fiber coupler 70. The source fiber 68 is in some examples preferably a single-mode fiber, having a core diameter less than 10 μm, or in some examples preferably less than 5 μm, and transmits all wavelengths of light that are used by interferometer 100 or interferometer 200, such as 450 nm to 800 nm, to the interferometer with minimal attenuation. Additionally, since the light output by the filter assembly 66 can be polarized, the source fiber 68 can have polarization-preserving or polarization-maintaining properties. Further, since the laser driver 62 and the fiber laser 64 generate heat, in this example the laser driver 62 and the fiber laser 64 are placed a sufficient distance from interferometer 100 or interferometer 200 so heat is not transferred to interferometer 100 or interferometer 200, either radiatively or by convection, so the performance of the interferometer is not affected by these heat generating sources. In this example the length of the source fiber 68 is at least one meter to provide the sufficient distance, or in other examples at least two meters, provided the length does not significantly attenuate any of the wavelengths transmitted by the source fiber 68.

Fiber coupler 70 is a three-port device that is used to either combine or to split optical signals being transmitted through fiber-optics. In the example shown in FIG. 2, fiber coupler 70 has an input coupled to an output of source fiber optic 68, an output coupled to an input of output fiber 72, and a two-way bidirectional (i.e., input and output) port coupled to input/output fiber 102. Fiber coupler 70 can be a single-mode fiber-optic device and must transmit at least a portion of all wavelengths of light (through all three ports) that are used by interferometer 100 or interferometer 200 for the displacement-measuring process. A typical device that can be employed for use as fiber coupler 70 is the Thorlabs (Newton, NY, USA) TW560R3A1 which is a wide-band, 2×1, single-mode, 50:50 coupler having a 250 nm optical bandwidth centered on 560 nm. Light entering coupler 70 from source fiber 68 is transmitted by coupler 70 into input/output fiber 102, and light entering coupler 70 from input/output fiber 102 is transmitted by coupler 70 into output fiber 72.

The input/output fiber 102 is used to couple the light output by coupler 70 to interferometer 100 or interferometer 200 as well as to couple light output by interferometer 100 or interferometer 200 to coupler 70. The input/output fiber 102 is in some examples preferably a single-mode fiber, having a core or aperture 103 diameter less than 10 μm, or in some examples preferably less than 5 μm, and transmits all wavelengths of light that are used by interferometer 100 or interferometer 200, such as 450 nm to 800 nm, to (and from) interferometer 100 or interferometer 200 with minimal attenuation. Additionally, since the light output by the filter assembly 66 can be polarized, input/output fiber 102 can have polarization-preserving or polarization-maintaining properties. Further, since laser driver 62 and the fiber laser 64 generate heat, in this example the laser driver 62 and the fiber laser 64 are placed a sufficient distance from interferometer 100 or interferometer 200 so the performance of interferometer 100 or interferometer 200 is not affected by these heat generating sources. In this example the length of the input/output fiber 102 is at least one meter to provide the sufficient distance, or in other examples at least two meters, provided the length does not significantly attenuate any of the wavelengths transmitted by the input/output fiber 102.

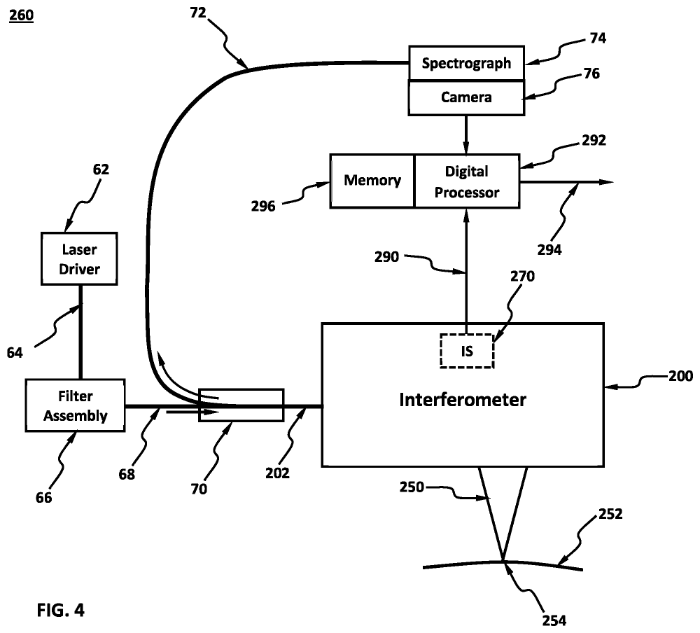

Interferometer 100 and interferometer 200 are devices for creating interfering beams of light that can be used to measure a displacement to a measurement surface 152 or 252, respectively. Interferometer 200 is similar (but not identical) in form to interferometer 100 but interferometer 200 has a calibration arm 278 that is not present in interferometer 100 as discussed below in connection to FIGS. 4 through 7B.

Referring to FIG. 3, a more detailed view of an example of interferometer 100 of interferometer system 60 from FIG. 2 is illustrated. Interferometer 100 can comprise a base 160 on which is installed a fiber mount 104, a first collimator mount 112 on which is mounted first parabolic collimator 110, a beamsplitter 118, an iris 134, a reference mirror 130, a second collimator mount 146 on which is mounted second parabolic collimator 144, although interferometer 100 may have other types and/or numbers of other components and/or other elements in other configurations. Interferometer 100 can be composed of three arms, such as input/output arm 107 which includes the optics of interferometer 100 to the left of beamsplitter 118 in FIG. 3; a reference arm 124 which includes the optics of interferometer 100 above beamsplitter 118 in FIG. 3; and a measurement arm 140 which includes the optics of interferometer 100 to the right of beamsplitter 118 in FIG. 3. The components comprising interferometer 100 can be oriented on or with respect to an input/output arm axis 108, a collimated light axis 116, a reference arm axis 126, and a measurement axis 148, although interferometer 100 may have other types and/or numbers of other axes and/or other axes in other configurations. Note that input/output arm axis 108 can be substantially perpendicular to collimated light axis 116 and that collimated light axis 116 can be substantially perpendicular to reference arm axis 126 and to measurement arm axis 148, and that all axes can substantially reside in the same plane (e.g., the X-Z plane as depicted in FIG. 3).

Base 160 is the platform or “optical bench” on which the components—or their mounts—comprising interferometer 100 are installed. Base 160 can be rectangular cuboid in shape and in some examples is preferably composed of a material that has a low coefficient of thermal expansion (CTE), such as Zerodur®, ULE®, or Invar®. That is, because interferometer 100 is sensitive to changes in optical path length in the measurement arm 140 and the reference arm 124 on the order of nanometers or even picometers, the base 160 on which the components of the interferometer 100, namely beamsplitter 118, reference mirror 130, and second parabolic collimator mount 146, are mounted should not expand or contract appreciably when small changes in ambient temperature occur. The CTE of the material of base 160 should be less than 1 part per million (PPM) per degree C, or in some examples preferably less than 100 PPB (parts per billion), or in some examples more preferably the CTE of the material of base 160 is less than 10 PPB. As an example, if the reference arm temperature changes by 0.1 degrees C, the optical path length of the reference arm is 100 mm, and the CTE of the material of base 160 is 100 parts per billion (PPB) per degree C, then the optical path length of the reference arm will change by 10⁻⁹ meters or 1 nanometer—an amount much greater than the resolution and repeatability of this example of this technology. Base 160 can also have features machined into one or more of its surfaces to facilitate locating, placement, or mounting of the components coupled to the base 160, such as fiber mount 104, beamsplitter 118, reference mirror 130, iris 134, and/or second collimator mount 146 or for adjusting or aligning these components while interferometer 100 is being assembled. Base 160 can also have features or provisions to facilitate the mounting or attachment of interferometer 100 into a metrology or positioning system such as a CMM (coordinate measurement machine). The thickness (in the Y-direction of FIG. 3) of base 160 can be between 2 mm and 100 mm; the width (in the X-direction of FIG. 3) can be between 40 mm and 1000 mm; and the height (in the Z-direction of FIG. 3) can be between 40 mm and 1000 mm.

Fiber mount 104 is used to securely position input/output fiber 102 with respect to the other optical components of interferometer 100. Fiber mount 104 can be a block of low-CTE material with a thru-hole in which input/output fiber 102 is securely installed. In some examples, fiber mount 104 is preferably made from the same material as base 160 so the mechanical properties (such as the CTE) of the two components are substantially identical so stresses or movements are not induced in either of the components with small changes in temperature. As such, fiber mount 104 can in some examples preferably be composed of ULE®, Zerodur®, or Invar® materials. Fiber mount 104 can also have features machined into one or more of its surfaces to facilitate aligning, locating, placement, or mounting of the fiber mount 104 on base 160. Fiber mount 104 can also have features machined into one or more of its surfaces to facilitate locating, adjusting, aligning, or mounting of the input/output fiber 102 within fiber mount 104 and/or other optical component of interferometer 100.

First parabolic collimator 110 is used to 1) collimate the diverging cone of light within input output light cone 106 emitted by input output fiber 102 into collimated light 114 and redirect by reflection the input light from being substantially centered on input/output arm axis 108 to collimated light axis 116 and 2) focus the substantially collimated light present in collimated light 114 incident on parabolic collimator onto the aperture 103 of input output fiber 102 and redirect by reflection the collimated light 114 from being substantially centered on collimated light axis 116 to being substantially centered on input/output arm axis 108. First parabolic collimator 110 can be a right angle parabolic collimator and can have a focal length between 5 mm and 500 mm, said focal length also being the distance between the first parabolic collimator 110 and the aperture 103 of input output fiber 102 along input/output arm axis 108. First parabolic collimator 110 can be composed of a material having a low CTE such as less than 1 ppm per degree C and have an aperture of between 1 mm and 100 mm. First parabolic collimator 110 is reflective to a broad band of wavelengths such that it reflects light having a wavelength greater than 600 nm, or in some examples preferably greater than 500 nm, or in some examples more preferably greater than 450 nm. Additionally, first parabolic collimator 110 can reflect wavelengths less than 700 nm, or in some examples preferably less than 800 nm. A reflective material can be installed atop the parabolic surface of first parabolic collimator 110, said reflective material can be a metal such as aluminum, silver, gold, or even silicon, and can have a thin transparent protective coating, such as silicon dioxide, installed atop the reflective coating. The reflectivity of the parabolic surface of first parabolic collimator 110 can be greater than 50% over the relevant range of wavelengths, or in some examples preferably greater than 80%, or in some examples more preferably greater than 90%.

First parabolic collimator 110 can be coupled or mounted directly to base 160 or in some examples more preferably to first collimator mount 112 which is coupled to base 160 to facilitate alignment of first parabolic collimator with other opto-mechanical components of interferometer 100. First parabolic collimator 110 can also be purchased as an assembly with integrated fiber mount 104, such as the reflective collimator having part number RC08APC-P01 (33 mm focal length, 11 mm clear aperture) from Thorlabs (Newton, NJ, USA).

Beamsplitter 118 is used to split the light of collimated light 114 beam from first parabolic collimator 110 into collimated reference arm light 128 substantially centered on reference arm axis 126 and collimated measurement light 142 substantially centered on collimated light axis 116, as well as to recombine light from reference light 136 on reference arm axis 126 and collimated measurement light 142 on collimated light axis 116 into collimated light 114 on collimated light axis 116 and direct the recombined light towards first parabolic collimator 110. Importantly, these beams do not pass through a solid optically-transmissive medium, such as glass, but instead the beamsplitting occurs reflectively with reflective surface 122 acting cooperatively with beamsplitter aperture 120. Reflective surface 122 is in some examples preferably substantially planar and can be the hypotenuse of a right-angle prism as shown in FIG. 3. The peak-to-valley unflatness of reflective surface 122 should be a fraction of the wavelength of the light used by interferometer, such as flatter than λ/10 or less than 50 nm peak-to-valley over that portion of reflective surface 122 that collimated 114 from parabolic collimator 110 is incident on. Beamsplitter 118 can also have an aperture 120 that is substantially co-axial with collimated light axis 116 through which collimated measurement light 142 pass to and from the measurement arm 140. The cross-sectional shape of beamsplitter aperture 120 is in some examples preferably circular and have a radius between 0.05 mm and 25 mm.

In this example, the beamsplitter 118 is in some examples preferably made from the same material as base 160 so the mechanical properties (such as the CTE) of the two components are substantially identical so stresses, movements, or deformations are not induced in either of the components with small changes in temperature. As such, beamsplitter 118 can be preferably composed of ULE®, Zerodur®, or Invar® materials. Beamsplitter 118 can also have features machined into one or more of its surfaces to facilitate locating, adjusting, aligning, or mounting of the beamsplitter 118 on base 160 and/or with respect to other optical component of interferometer 100. Reflective surface 122 is reflective to a broad band of wavelengths such that it reflects light having a wavelength greater than 500 nm, or in some examples preferably greater than 450 nm. Additionally, the reflective coating of reflective surface 122 can reflect wavelengths less than 700 nm or in some examples preferably less than 800 nm. The reflective coating of reflective surface 122 can be composed of a metal such as aluminum, silver, gold, or even silicon, and can have a thin transparent protective coating, such as silicon dioxide, installed atop the reflective coating. The reflectivity of reflective surface 122 can be greater than 50% over the relevant range of wavelengths, or in some examples preferably greater than 80%, or in some examples more preferably greater than 90%.

As mentioned earlier, iris 134 and reference mirror 130 having reference surface 132 combine to form the reference arm 124 of interferometer 100. Iris 134 and the clear aperture of reference surface 132 are both substantially centered on reference arm axis 126. Reference mirror 130 is in some examples preferably composed of the same material as base 160 so the mechanical properties (such as the CTE) of the two components are substantially identical so stresses, movements, or deformations are not induced in either of the components with small changes in temperature. As such, reference mirror 130 can be in some examples preferably composed of ULE®, Zerodur®, or Invar® materials. Reference mirror 130 can also have features machined into one or more of its surfaces to facilitate locating, adjusting, aligning, or mounting of the reference mirror 130 on base 160 and/or with respect to other optical component of interferometer 100. A separate mount can be provided between reference mirror 130 and base 160 to facilitate the alignment and installation of reference mirror 130 into interferometer 100. Reference surface 132 is reflective to a broad band of wavelengths such that it reflects light having a wavelength greater than 500 nm, or in some examples preferably greater than 450 nm. Additionally, the reflective coating of reference surface 132 can reflect wavelengths less than 700 nm or in some examples preferably less than 800 nm. The reflective coating of reference surface 132 can be composed of a metal such as aluminum, silver, gold, or even silicon, and can have a thin transparent protective coating, such as silicon dioxide, installed atop the reflective coating. The reflectivity of reference surface 132 can be greater than 50% over the relevant range of wavelengths, or in some examples preferably greater than 80%, or in some examples more preferably greater than 90%. The peak-to-valley unflatness of reference surface 132 should be a fraction of the wavelength of the light used by interferometer, such as flatter than λ/10 or less than 50 nm peak-to-valley over the aperture of reference surface 132.

Iris 134 is a diaphragm with an aperture whose width is adjustable. Iris 134 can be substantially centered on reference arm axis 126 and have a minimum aperture width of less than 2.0 millimeters and a maximum aperture width greater than 6.0 millimeters. The width of the aperture of iris 134 can be set once and then fixed, or the width of the aperture can be manually adjusted as needed, or the width of the aperture can be adjusted via a motorized mechanism as needed. Iris 134 can be used to control the amount of reference light transmitted through the reference arm, and can be part number D12S from Thorlabs, Newton, NJ, USA.

Second parabolic collimator 144 is used to 1) focus the substantially collimated light present in collimated measurement light 142 incident on second parabolic collimator 144 onto the measurement surface 152 thereby forming measurement spot 154 and redirect by reflection the collimated measurement light 142 from being substantially centered on collimated light axis 116 to being substantially centered on measurement axis 148, and 2) collimate the diverging cone of light in measurement light cone 150 from measurement spot 154 into collimated measurement light 142 and redirect by reflection the measurement arm light 150 from being substantially centered on measurement axis 148 to collimated light axis 116. Second parabolic collimator 144 can be a right angle parabolic collimator and can have a focal length between 5 mm and 500 mm, said focal length also being approximately the distance between the second collimator 144 and measurement spot 154 on measurement surface 152 along measurement axis 148. Second parabolic collimator 144 can be composed of a material having a low CTE such as less than 1 ppm per degree C and have an aperture of between 1 mm and 100 mm. Second parabolic collimator 144 has parabolic surface 186 that is reflective to a broad band of wavelengths such that it reflects light having a wavelength greater than 500 nm, or in some examples preferably greater than 450 nm. Additionally, parabolic surface 186 of second parabolic collimator 144 can reflect wavelengths less than 700 nm or in some examples preferably less than 800 nm. Parabolic surface 186 can be composed of a reflective material such as a metal such as aluminum, silver, gold, or even silicon, and can have a thin transparent protective coating, such as silicon dioxide, installed atop the reflective layer. The reflectivity of the parabolic surface 186 of second parabolic collimator 144 can be greater than 50% over the relevant range of wavelengths, or in some examples preferably greater than 80%, or more in some examples preferably greater than 90%. Second parabolic collimator 144 can be coupled or mounted directly to base 160 or in some examples more preferably to second collimator mount 146 which is coupled to base 160 to facilitate alignment of second parabolic collimator 144 with other opto-mechanical components of interferometer 100.

Importantly, in this example input/output fiber mount 104, beamsplitter 118, reference mirror 130 (and/or its mount if present), second collimator mount 146, and base 160 are in some examples preferably fabricated from a material having a low CTE (coefficient of thermal expansion) such as Invar® (a metal) or a glass such as fused silica, ULE®, or Zerodur®. Further, in this example these components are in some examples preferably fabricated from the same material (i.e., not some made from Invar® and others from ULE®) so their CTE's are substantially identical which will preclude the presence of temperature-induced stresses and strains which can cause nanometer-scale movements, or even sub-nanometer scale movements, of the optical components comprising interferometer 100 which can cause measurement inaccuracies at this scale. Additionally, the method by which the input/output fiber mount 104, beamsplitter 118, reference mirror 130 (and/or its mount if present), second collimator mount 146 are bonded or attached to base 160 should also not cause temperature-induced stresses and strains which can cause nanometer-scale movements, or even sub-nanometer scale movements, of the components. For example, if the optical components are all fabricated from ULE®, then an organic UV-cured adhesive or metallic screws should not be employed to fasten the components together. In some examples, a more preferable way to join the optical components of interferometer 100 together in another example is to fabricate base 160, input/output fiber mount 104, beamsplitter 118, reference mirror 130 (and/or its mount if present), second collimator mount 146 from ULE® (or Zerodur®) and then use a mixture of water, sodium hydroxide, and sodium silicate to bond the components together. With this process, known at times as hydroxide catalysis bonding, it is known that when the water evaporates, the sodium hydroxide and sodium silicate cause the glasseous optical components to chemically combine with one another such that they in effect become a unitary glass object. The resulting unitary glass object has substantially the same thermal and mechanical properties as the original glass of which the bonded components are composed.

Continuing with reference to FIG. 2, interferometer system 60 can also include a spectrograph 74 whose input is coupled to an output of output fiber 72. Spectrograph 74 is an optical instrument that is used to spectrally disperse an optical signal into a spectrum of wavelengths, such that the constituent wavelengths, which are generally unknown but are desired to be known, within the optical signal can be analyzed. Spectra produced by spectrograph 74 is coupled to an input of camera 76 that captures imagery of the spectra produced by the spectrograph 74. That is, the output of the spectrograph 74 is an optical signal being presented as intensity as a function of wavelength, and an image of this optical signal is subsequently presented to camera 76 which captures the image, converts the image to an electronic format, and transmits the electronically formatted spectral image to the digital processing system 78 for processing. The spectrograph 74 nominally has the same spectral bandwidth as the free spectral range, or chromatic range, of the interferometer 100, such as the 500 nm to 700 nm or 450 nm to 800 nm spectral ranges cited earlier. The spectral resolution of spectrograph 74 in this example is fine enough that the individual interference fringes within the interferogram can be resolved. Therefore, the resolution of the spectrograph 74 can be better than 100 pm (100 picometers), or in some examples preferably less than 50 pm, or in other examples better than 20 pm. One such spectrograph that meets these requirements is the Hornet Hyperfine Spectrometer from LightMachinery Inc., Ottawa, Ontario, Canada.

The camera 76 captures an image of the optical signal or spectrum created by the spectrograph 74 and converts the image to an electronic format. In one example, the camera 76 is a line camera, wherein the image sensor of the camera 74 comprises a row of pixels arranged linearly, and onto which a spectral image is projected by spectrograph 74. In such a case, there can be between 256 and 16,384 pixels in the image sensor whose length can be up to 100 mm, and the imaging frame rate can be up to 200,000 captured images per second. Alternately, spectrograph 74 and camera 76 may be operative with two-dimensional spectral images. In this two-dimensional example, the camera 76 can have an image sensor whose pixels are arranged in a two-dimensional array wherein the pixel count can be from 640×480 pixels up to 10,000×5000 pixels, the size of the image sensor can be from 3.2 mm×2.4 mm up to 50 mm×25 mm, and the frame rate can be between 10 images/second up to 50,000 images/second. The camera 76 in this example is a monochrome camera (as opposed to color) and has a gray-scale bit depth of from 8 bits up to 20 bits, although other types of cameras may be used. The output of camera 76 is coupled to an input of a digital processing system 78.

The digital processing system 78 may include one or more processors and/or a communication interface, which are coupled together by a bus or other communication link, although the digital processor system 78 can include other types and/or numbers of elements in other configurations and also other types of processing systems may be used. The processor(s) of digital processor system 78 may execute programmed instructions stored in memory 82 for any number of the functions described and illustrated herein. The processor(s) of digital processor system 78 may include one or more CPUs or general-purpose processors with one or more processing cores, for example, although other types of processor(s) can also be used although the digital processor system 78 may comprise other types and/or numbers of components and/or other elements in other configurations.

The memory 82 associated with digital processor system 78 stores these programmed instructions for one or more aspects of the present technology as described and illustrated herein, such as for generating spectral content values of light output by interferometer 100 and for determining displacement or some other property of measurement surface 152 described and illustrated herein for execution by the processing unit by way of example, although some or all of the programmed instructions could be stored elsewhere. A variety of different types of memory storage devices, such as random access memory (RAM), read only memory (ROM), hard disk, solid state drives, flash memory, or other computer readable medium which is read from and written to by a magnetic, optical, or other reading and writing system that is coupled to the processor(s), can be used for memory 82.

The communication interface of the digital processor system 78 operatively couples and communicates to the camera 76 by a communication system, although other types and/or numbers of communication systems with other types and/or numbers of connections and/or configurations to other devices and/or elements can also be used.

By way of example only, the digital processing system 78 also could be a conventional microprocessor with an external memory, such as memory 82, or the digital processing system 78 can be a microcontroller with all memory located onboard. In another example, the digital processing system 78 could be a digital signal processor (DSP) integrated circuit, which is a microcomputer that has been optimized for digital signal processing applications, including centroid computations, regression, and curve-fitting. In yet another example, the digital processing system 78 could be a graphical processing unit (GPU) integrated circuit, which is a microcomputer that has been optimized for parallel-processing applications. The digital processing system 78 could be as simple as a sixteen-bit integer device for low-cost applications or the digital processing system 78 can be a thirty-two bit or sixty-four bit or higher floating-point device or system for higher performance when cost is not an issue. Also, by way of example only, the digital processing system 78 could be an FPGA (Field-programmable gate array) or a CPLD (complex programmable logic device) which are attractive for use in examples of this technology owing to their compact and cost-effective hardware implementations.

Referring again to FIG. 2, in operation broadband light produced by fiber laser 64 enters filter assembly 66 whereupon filter assembly 66 removes unused or otherwise undesirable wavelengths of light from the output of fiber laser 64. As an example, if fiber laser 64 produces light having wavelengths between 450 nm and 2400 nm, and only wavelengths from 450 nm to 800 nm are actually used by interferometer 100, then filter assembly 66 can remove wavelengths from 800 nm to 2400 nm so those wavelengths do not enter interferometer 100 and possibly cause heating and thermal gradients within interferometer 100 and degrade the performance of interferometer 100. Light that passes through filter assembly 66 then enters source fiber optic 68, passes through fiber coupler 70 and enters interferometer 100 through aperture 103 of input/output fiber 102.

Referring now to FIG. 3, light exiting input/output fiber 102 as it enters interferometer 100 diverges, due to diffraction, and forms input/output light cone 106 which is substantially centered upon input/output arm axis 108. The included angle of input/output light cone 106 is determined by the emission angle of the light exiting single-mode input/output fiber 102. Diverging light exiting input/output fiber 102 within light cone 106 propagates to first parabolic collimator 110. Since the aperture 103 of input/output fiber 102 is substantially located at the focal position of first parabolic collimator 110, then the light that is reflected from first parabolic collimator 110 will be collimated, such as collimated light 114. Further, if first parabolic collimator 110 is a right-angle parabolic collimator and if collimated light axis 116 is perpendicular to input/output arm axis 108, then collimated light 114 will be substantially centered on collimated light axis 116.

Collimated light 114 from first parabolic collimator 110 then becomes incident on the hypotenuse of beamsplitter 118. The hypotenuse of beamsplitter 118 has a reflective surface 122 with an aperture 120 installed through the reflective surface 122 as well as through the bulk of beamsplitter 118 along collimated light axis 116. Accordingly, that portion of collimated light 114 incident upon reflective surface 122 is reflected into reference arm 124 and that portion of collimated light 114 incident on aperture 120 is transmitted through beamsplitter 118 along collimated light axis 116. If beamsplitter 118 is a right-angle prism such that the hypotenuse underlying reflective surface 122 is at a substantially 45° angle with respect to collimated light axis 116, then the collimated light 128 reflected from reflective surface 122 is reflected into a direction that is parallel to (or even co-axial with) reference arm axis 126, wherein reference arm axis 126 is perpendicular to collimated light axis 116.

Collimated light 128 reflected from reflective surface 122 propagates through reference arm 124 until it reaches iris 134. Iris 134 has an adjustable aperture that controls or limits the amount of light traveling through reference arm 124. Iris 134 is provided and its aperture is adjusted so that the amount of light passing through the reference arm 124 can be approximately the same (within a factor of two) as the amount of light passing through measurement arm 140 of interferometer 100. Having the amount of light being balanced in this manner (again, with a factor of two or so) improves the signal-to-noise ration (SNR) of the resulting spectral interference fringes, and accordingly, the repeatability of the measurements of measurement surface 152. Alternately, iris 134 can be kept in a fully open position so that the “interferometric gain” provided by a high-brightness reference arm can be used to amplify a weak return from measurement surface 152 should measurement surface 152 be optically uncooperative (e.g., non-reflective), although the interferometric gain occurs at the expense of noisier spectral fringes or at the expense of possibly saturating the camera 76 associated with spectrograph 74. The operation of iris 134 (i.e., the width of the iris's aperture), can be manually controlled or driven by a motor coupled to an output of digital processor 78. The amount of light attenuation provided by the aperture of iris 134 can be between 0% and 99.9%. That portion of reference arm light 128 that passes through iris 134 is reference light 136.

Reference light 136 propagates through iris 134 along reference arm axis 126 until it reaches reflective reference surface 132 of reference mirror 130, whereupon reference light 136 reflects from the substantially planar reflective reference surface 132 and substantially retraces its path back through iris 134 to reflective surface 122 of beamsplitter 118 whereupon the light reflects from reflective surface 122 of beamsplitter 118 into a direction substantially centered on collimated light axis 116 until it reaches first parabolic mirror 110 whereupon it further reflects from first parabolic mirror 110 into a direction substantially centered on input/output arm axis 108 within input/output light cone 106 and by virtue of the optical power within first parabolic mirror 110 the reference light within input/output light cone 106 comes to a focus substantially coincident with the aperture 103 of input/output fiber 102 whereupon a substantial fraction of the reference light enters into the input/output fiber 102.

Collimated light 114 from first parabolic mirror 110 that is not reflected from reflective surface 122 propagates through beamsplitter aperture 120 through beamsplitter 118 and exits beamsplitter 118 into measurement arm 140 as collimated measurement light 142 substantially along collimated light axis 116. Collimated measurement light 142 then propagates further until it is incident on parabolic surface 186 of second parabolic collimator 144 which reflects the incident collimated measurement light 142 into a direction substantially centered on measurement axis 148. Further, due to the optical power present in parabolic surface 186 of second parabolic collimator 144, second parabolic collimator 144 also focuses the reflected light into converging measurement light 150 that comes to a focus, or near-focus depending on the contour of measurement surface 152, at measurement spot 154 on measurement surface 152 along measurement axis 148.

Measurement surface 152 then specularly reflects at least a portion of the focused measurement light 150 back into the measurement arm 140 of interferometer 100, although the back-reflected light may not be centered on measurement axis 148 if the measurement surface 152 is tilted or sloped. Nonetheless, at least a portion of the back-reflected light will reach parabolic surface 186 of second parabolic collimator 144 which collimates the light and directs it into a direction substantially parallel to collimated light axis 116 whereafter it pass through beamsplitter aperture 120 of beamsplitter 118 until it reaches first parabolic mirror 110 whereupon it further reflects from first parabolic mirror 110 into a direction substantially centered on input/output arm axis 108 within input/output light cone 106 and by virtue of the optical power within first parabolic mirror 110 the measurement light comes to a focus substantially coincident with the aperture 103 of input/output fiber 102 whereupon a substantial fraction of the measurement light enters into the input/output fiber 102.

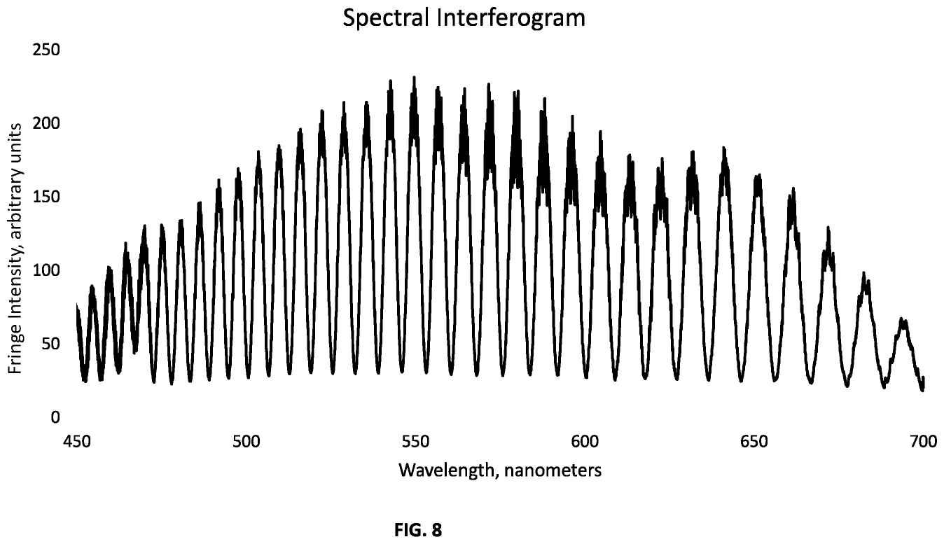

Continuing with reference to FIG. 2, the reference light that enters input/output fiber 102 and the measurement light that enters input/output fiber 102 propagates through input/output fiber 102 with minimal propagation loss until these light signals encounter fiber coupler 70 whereupon a substantial portion of both reference and measurement light signals exit the fiber coupler 70 into output fiber 72. Measurement and reference light signals that enter output fiber 72 are then transmitted though output fiber 72 with minimal propagation loss until these light signals reach spectrograph 74. Spectrograph 74 then spectrally disperses the measurement and reference light signals input to the spectrograph 74, and projects the spectrally dispersed light signals onto the image sensor of camera 76 whereupon the measurement and reference light signals optically interfere with one another to produce a spectral fringe pattern, as shown in FIG. 8, on the image sensor in accordance with Equation 1:

$${I}_{F} = {I}_{R} + {I}_{M} + 2 \sqrt{{I}_{R} {I}_{M}} cos ( \frac{2 π}{λ} OPD ) \qquad Equation 1$$

where I_{F} is the intensity of the resulting fringe pattern (at a particular wavelength), I_{R} is the intensity of the reference light, I_{M} is the intensity of the measurement light, and OPD is the optical path difference or the difference in the optical lengths of the measurement and reference arms of interferometer 100. The displacement to measurement surface 152 is encoded in the OPD term; λ denotes the wavelengths of light that interferometer 100 operates with, such as 450 nm to 800 nm, and the spectral fringe pattern, I_{F}(λ), is that signal that is formed on the image sensor of camera 76 which then generates an electronic version of Equation 1 that is subsequently analyzed and processed by digital processing unit 78 to determine the displacement to measurement surface 152.

The OPD or optical path difference is equal to the difference in the optical path length of the measurement arm (OPL_{M}) and the optical path length of the reference arm (OPL_{R}), or

OPD=OPL_{M}-OPL_{R} Equation 2

Referring for the moment to FIG. 3, OPL_{R} is twice the distance from where the collimated light axis 116 and reference arm axis 126 intersect the hypotenuse of beamsplitter 118 (this point will hereafter be referred to as the “fulcrum point”) to the reference surface 132 along reference arm axis 126. OPL_{M} is twice the distance from the fulcrum point to where collimated light axis 116 (and measurement axis 148) intersects the parabolic surface 186 of second parabolic mirror 144 plus twice the distance from where the collimated light axis 116 and measurement arm axis 148 intersect the parabolic surface 186 of second parabolic collimator to the measurement surface 152 along measurement arm axis 148. The lengths of OPL_{M} and OPL_{R} can be between 5.0 and 500 millimeters, and OPD can be between −100 mm and +100 mm although an OPD value between −1.0 mm and 1.0 mm is more typical.

In optical terms the measurement spot 154 is confocal with the aperture 103 of input/output fiber 102, and measurement spot is an image of the aperture of input/output fiber 102. Associated with any imaging system is a magnification, M, which for this example is the ratio of the width of the measurement spot 154 and the width of the aperture 103 of the input/output fiber 102. The magnification M is determined by the ratio of the focal lengths of the second parabolic mirror 144 and the first parabolic mirror 110, i.e., M=f₂/f₁, where f₂ is the focal length of second parabolic mirror 144 and f₁ is the focal length of the first parabolic collimator 110. If, for example, the focal length of the first parabolic collimator 110 is 33 mm, i.e., f₁=33 mm, and the focal length of the second parabolic collimator 144 is 50 mm, i.e., f₂=50 mm, and the width of the aperture 103 of input/output fiber 102 is 5 μm, then M=50/33=1.515 and the width of measurement spot 154 is 7.58 μm when the elevation of measurement surface 152 at measurement axis 148 is at the optimal focus position in Z. The value of magnification, M, can be between 0.1 and 10.0.

The output 80 of interferometer system 60 is an electronic signal line that couples an output of digital processing system 78 to an input of a downstream electronic device such as a client computer or a display (not shown). As such interferometer system output 80 is typically a serial bus such as USB or SPI bus, for inter-computer communications, or HDMI in the case where the downstream electronic device is a display. The data communicated through interferometer system output 80 bus can be the displacement measured by interferometer system 60, as well as other data, such as meta-data (such as, for example, the date and time of the measurement, the speed of the measurement, details about the object having measurement surface 152 being measured, etc.) about the displacement measurement process.

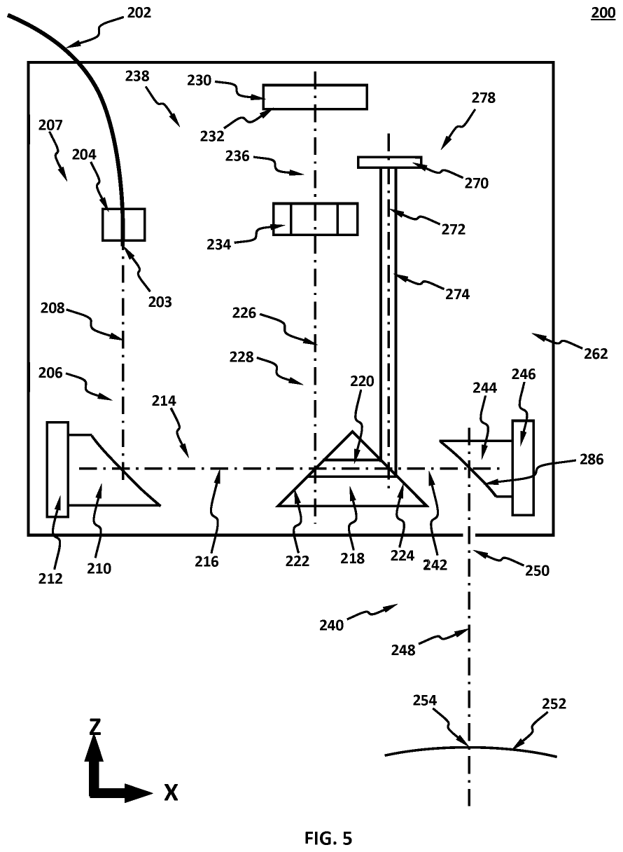

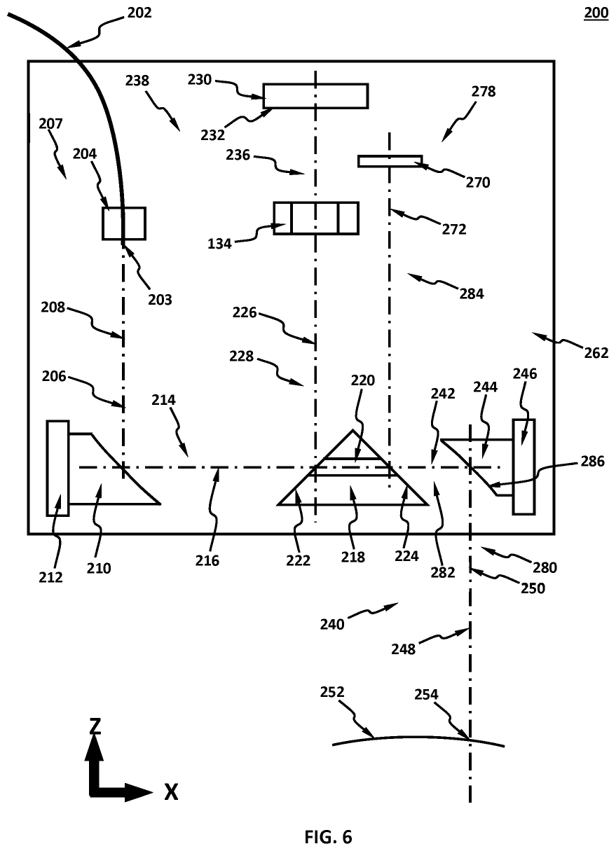

Interferometer system 60 has phenomenal measurement repeatability, as low as 10 picometers one standard deviation. In a metrology system that has no systematic measurement errors then measurement repeatability is also a good proxy for measurement accuracy. Unfortunately, interferometer 100 of interferometer system 60 has systematic errors that potentially introduce several nanometers of displacement measurement error. Since measurement surface 152 is generally not planar, either by design or by having surface errors that cause the measurement surface 152 to not be orthogonal to measurement arm axis 148 at measurement spot 154, then the light reflected from measurement surface 152, such as returned measurement light 280 as shown in FIG. 6, will not be centered on measurement arm axis 148 or 248 but instead will be centered on an axis that is at an angle with the measurement arm axis 148 or 248 in which the angle is two times the slope angle of the measurement surface 152 at measurement spot 154 (or two times the slope angle of the measurement surface 252 at measurement spot 254 as shown in FIG. 6). As such, returned measurement light 280 will be incident on different areal locations of parabolic surface 186 or 286 of second parabolic collimator 144 or 244 respectively in accordance with the tilt or slope of measurement surface 152 or 252 respectively, and because the reflective parabolic surface 186 or 286 of second parabolic collimator 144 or 244 respectively cannot be fabricated perfectly and some portions of the reflective parabolic surface 186 or 286 of second parabolic collimator 144 or 244 respectively will be higher or lower than the ideal parabolic prescription (i.e., protrude above or below the ideal surface), the optical path length of rays travelling from measurement spot 154 or 254 to the aperture “fulcrum” (defined earlier to be where the collimated light axis 116 and reference arm axis 126 intersect the hypotenuse of beamsplitter 118, or per FIG. 6, where the collimated light axis 216 and reference arm axis 226 intersect reflective surface 222 of beamsplitter 218) will vary in accordance with the surface error of the reflective parabolic surface 186 or 286 of second parabolic collimator 144 or 244 respectively which in turn will vary depending on the local tilt or slope of measurement surface 152 or 252 at the location of measurement spot 154 or 254. That is, the optical path length of the measurement arm rays (i.e., OPL_{M}), i.e., those rays travelling from measurement spot 154 or 254 to the “fulcrum” will vary in accordance with the slope angle of measurement surface 152 or 252 due to the surface figure errors of the reflective parabolic surface 186 or 286 of second parabolic collimator 144 or 244 respectively. These systematic errors will hereinafter be called “retrace errors.” The interferometer system 60 can have measurement accuracies of a few tens of picometers if there were no systematic errors in the optics, such as less than 50 picometers, or even less than 20 picometers. However, the measurement accuracy is compromised by the surface figure errors of the reflective parabolic surface 186 or 286 of second parabolic collimator 144 or 244, respectively. Fortunately, if the slope angle of the measurement surface 152 or 252 is known at the measurement spot 154 or 254, and if the systematic measurement errors as a function of the slope angle of the measurement surface 152 or 252 at measurement spot 154 or 254 can be determined in a calibration process, then the slope-dependent errors can be removed during the displacement measurement process. This calibration and correction process requires knowledge of the slope angle of the measurement surface 152 or 252 at the measurement spot 154 or 254. A second example of this technology as described below in connection with FIG. 5 and FIG. 6 has provisions for such a calibration and correction process.

### Second Example

A second example for measuring the displacement to a measurement surface will now be described with reference to FIG. 4 through FIG. 6. The claimed technology provides a number of advantages including providing a displacement measurement system that has a fast displacement measurement rate and high accuracy, even when the surface being measured is sloped or tilted. As seen in FIG. 4, interferometer system 260 includes a laser driver 62, fiber laser 64, filter assembly 66, source fiber 68, fiber coupler 70, output fiber 72, spectrograph 74 and associated camera 76 that are substantially the same as those employed in the first example as described above in connection with FIG. 2 and FIG. 3. Interferometer system 260 also includes input/output fiber 202 having aperture 203, interferometer 200 having measurement light 250, a digital processor 292 having memory 296 and having an input coupled through image sensor output line 290 to an output of an image sensor 270 within interferometer 200; these components may or may not have similarities to components described earlier in connection to FIG. 2, and are described in more detail below.

Referring for the moment to FIG. 5, interferometer 200 includes fiber mount 204, first parabolic collimator 210, first collimator mount 212, a reference mirror 230 with a reference surface 232, iris 234, second parabolic collimator 244 having parabolic surface 286 and accompanying second collimator mount 246, and base 262, as well as input/output axis 208, collimated light axis 216, reference arm axis 226, and measurement axis 248, wherein all said components and axes are similar in form and function to their counterparts employed in the first example as described in connection to FIG. 2 and FIG. 3. Note that input/output arm axis 208 can be substantially perpendicular to collimated light axis 216 and that collimated light axis 216 can be substantially perpendicular to reference arm axis 226 and to measurement arm axis 248, as well as to calibration arm axis 272, and that all axes can substantially reside in the same plane (e.g., the X-Z plane as depicted in FIG. 5).

Interferometer 200 also includes a beamsplitter 218, a calibration arm 278 having an image sensor 270, and a calibration axis that differ from the components employed in the first example as described in connection to FIG. 2 and FIG. 3; these differences are also described in more detail below.

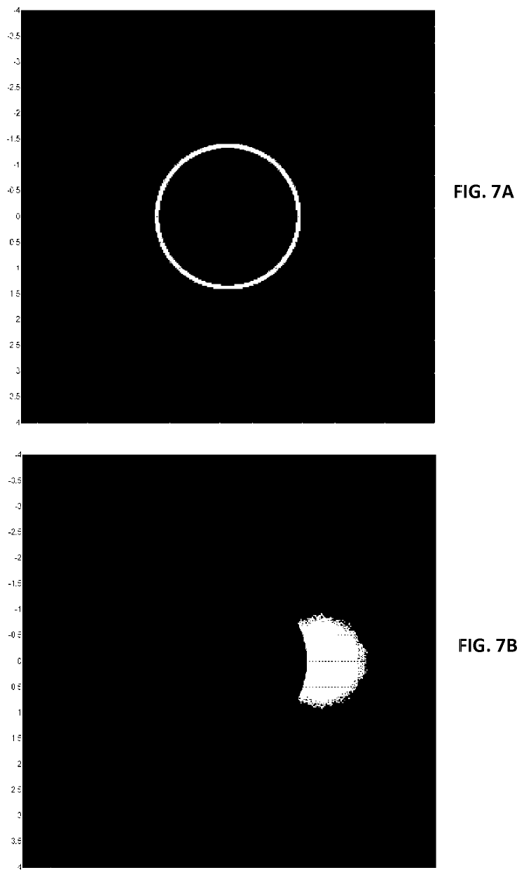

Continuing with reference to FIG. 5, beamsplitter 218 can be a right angle prism with its two short sides, reflective surface 222 and reflective surface 224, being mirrored and with an aperture 220 extending through the right angle prism from one short side to the other and substantially centered on collimated light axis 216. Other physical attributes of beamsplitter 218 are similar to the attributes of beamsplitter 118. Reflective surface 222 in particular performs similar to reflective surface 122 wherein reflective surface 222 functions to reflect light energy into reference arm 238 along reference arm axis 226 and also to reflect light energy reflected back from reference surface 232 of reference mirror 230 back towards the input/output arm 207 by way of collimated light bundle 214. Reflective surface 224 functions to reflect any light reflected back from second parabolic collimator 244 from the measurement arm 240 that misses aperture 220, into calibration arm light 274, into a direction substantially parallel to, but not necessarily centered on, calibration arm axis 272 of calibration arm 278. Calibration arm light 274, which is also substantially collimated, propagates until it reaches and is incident on image sensor 270 where it produces an image of the light that missed the opening of aperture 220. Importantly, if measurement surface 252 was perpendicular and unsloped at the location of measurement spot 254 on measurement arm axis 248 and if parabolic surface 286 of second parabolic collimator 244 was perfectly fabricated and free of surface error, then little or no measurement light 242 returned from measurement arm 240 would be reflected into calibration arm 278. But owing to imperfections in the parabolic surface 286 of second parabolic collimator 244 and/or poor focusing of measurement spot 254 on measurement surface 252, then a not insignificant amount of light, depicted as calibration arm light 274 in FIG. 5 will propagate through calibration arm 278. Further, this calibration arm light 274 will generate an image on image sensor 270, said image having an appearance such as that shown in FIG. 7A.

Image sensor 270 can be a rectangular array of pixels for sampling an image, wherein the array can be configured to have between 100 and 5000 pixels in one axis of the rectangular and between 100 and 5000 pixels in the second axis of the rectangle. A variety of different types of image sensors may be used, such as a photodetector. Image sensor 270 is typically silicon and is responsive to wavelengths of light between 400 nm and 1100 nm, although other materials and other responsivities are possible as well, including wavelengths up to 2400 nm. The individual pixels comprising image sensor 270 are typically square in shape, having a width between 1 μm and 16 μm. The frame rate of image sensor 270 is in some examples preferably substantially equal to the measurement rate of interferometer system 260 as a whole, although image sensor 270 can have slower frame rates as well. The frame rate of image sensor 270 can be between 10 and 1000 frames (or images) per second.

FIG. 6 illustrates the operation of the calibration arm 278 of interferometer 200 when measurement surface 252 is tilted or sloped at measurement spot 254 on measurement axis 248. As shown in FIG. 6, the returned measurement light 280 reflected from sloped or tilted measurement surface 252 is not centered on measurement axis 248 but is instead propagating back towards parabolic surface 286 of second parabolic collimator 244 at an angle with respect to measurement axis 248, said angle being substantially equal to twice the local slope or tilt of measurement surface 252 at measurement spot 254. Returned measurement light 280 becomes incident upon and reflects from parabolic surface 286 of second parabolic collimator 244, and is reflected as collimated returned measurement light 282 into a direction substantially parallel to collimated light axis 216. Note that collimated returned measurement light 282 is offset from collimated light axis 216 by an amount proportional to the amount of tilt or slope of measurement surface 252 at measurement spot 254 on measurement axis 248. Collimated returned measurement light 282 propagates towards reflective surface 224 of beamsplitter 218, and that portion of collimated returned measurement light 282 that is not incident on, and enter into, beamsplitter aperture 220, is instead incident on reflective surface 224 and reflected by reflective surface 224 as calibration arm light 284. Note that calibration arm light 284 is also substantially collimated and propagates toward image sensor 270 in a direction substantial parallel to calibration arm axis 272. Note that calibration arm light 284 is also offset from calibration arm axis 272 by an amount proportional to the amount of tilt or slope of measurement surface 252 at measurement spot 254 on measurement axis 248.

When calibration arm light 284 is incident upon image sensor 270 it forms an image of the cross-sectional intensity pattern of calibration arm light 284; such an image is shown in FIG. 7B. Note that the image of FIG. 7B has a generally circular perimeter but with a smaller portion to the left removed. The removed portion corresponds to that light which was incident on beamsplitter aperture 220 and not reflected by reflective surface 224 towards the image sensor 270. The outer diameter of the remaining portion is primarily determined by the diameter of beamsplitter aperture 220 which determines the diameter of collimated measurement light 242 which is substantially the same as the width of calibration arm light 284 (notwithstanding the missing portion). The size and location of the image formed on image sensor 270 with respect to calibration arm axis 272 is indicative of the amount of tilt or slope in measurement surface 252 at measurement spot 254. This tilt information can be used to correct the retrace error mentioned earlier as described in the following paragraphs.

Due to limitations in the fabrication of the parabolic surface 286 of second parabolic mirror 244, the actual topography of parabolic surface 286 will not be a perfect parabola but will instead have a topography that deviates slightly from a true parabola. The magnitude of these deviations can be up to ±100 nm in departure from a true parabola; the “+” of ±100 nm indicating that the surface is 100 nm above the best-fit parabola and the ‘−’ of ±100 nm indicating that the surface is 100 nm below the best-fit parabola of the actual topography of parabolic surface 286. Implicit in this description is that some portion(s) at some location(s) of parabolic surface 286 are higher elevations and other portion(s) at other location(s) of parabolic surface 286 are lower in elevation, and that the topography of parabolic surface 286 varies between these extremes across the surface of parabolic surface 286. Further, note that returned measurement light 280 is incident on, and reflects from, only a relatively small portion of parabolic surface 286, and that the location of this small portion on parabolic surface 286 varies in accordance with the tilt or slope of measurement surface 252 at measurement spot 254. Using the definition of OPL_{M} presented earlier in connection with Equation 2, it is clear to see how OPL_{M} can vary in accordance with what portion of parabolic surface 286 the returned measurement light 280 is incident on. Further, it is clear how OPL_{M} can vary in accordance with the tilt or slope of measurement surface 252 at measurement spot 254. Indeed, the variation of OPL_{M} with variations in the tilt or slope of measurement surface 252 at measurement spot 254, which in turn causes displacement measurement errors that vary with variations in the tilt or slope of measurement surface 252 at measurement spot 254 even though the actual real displacement to measurement surface 252 at measurement spot 254 is unchanged, is the retrace error.

The retrace error associated with interferometer 100 or interferometer 200 is caused by interactions between imperfections in parabolic surface 286 and the tilt or slope of the measurement surface 252 at the measurement location 254 and vary in magnitude in accordance with the magnitude of the surface errors of parabolic surface 286. That is, if we desire the displacement measurement accuracy of interferometer 100 or interferometer 200 to be less than 1 nanometer, then the error of parabolic surface 286 must be less than approximately 1 nanometer as well. Since it is not possible to economically fabricate parabolic surface 286 with less than 1 nm of surface error with current state-of-the-art optical production techniques, an alternate method is needed to eliminate the retrace error.

One such alternate method for eliminating, or at least minimizing, the retrace error is by the use of a calibration technique. In particular, if the amount of retrace error could be determined as a function of the tilt or slope of measurement surface 252 at measurement spot 254 for any amount or direction of said tilt or slope, and if the tilt or slope of measurement surface 252 at measurement spot 254 for any amount or direction of said tilt or slope could be measured, then the corresponding known amount of retrace error could be subtracted from the measured displacement to improve the accuracy of the displacement measurement.

Accordingly, the calibration arm 278 of the example illustrated in FIG. 5 can be used to determine the tip or slope of measurement surface 252 at measurement spot 254 for any amount or direction of said tilt or slope. Further, by using this tip or slope information of measurement surface 252 at measurement spot 254 in conjunction with the amount of retrace error that was determined a priori as a function of the tip, tilt, or slope of measurement surface 252 at measurement spot 254 then the determined retrace error can be subtracted from the displacement measurement thereby greatly improving the accuracy of the displacement measurement.

Importantly, for the retrace calibration process to work well, the tip, tilt, or slope of measurement surface 252 at measurement spot 254 must be accurately known. By analyzing the image captured by image sensor 270, which varies in accordance with the tip or slope of measurement surface 252 at measurement spot 254, the amount and direction of the tip or slope of measurement surface 252 at measurement spot 254 can be determined with great precision. The image analysis process can include centroiding or Fourier Transform algorithms as well as other transforms such as the Hough Transform. The image analysis process can be operative with measurement surface 252 tilts or slopes exceeding 5° or even 10°, or measurement surface 252 tilts or slopes less than 1 arc second or even less than 1 milli-arc second, and can have a resolution less than 1 milli-arc second or in some examples preferably less than 100 micro-arc second.

During the retrace calibration and characterization process (as well as in the displacement measurement process), image data from image sensor 270 is output by the image sensor 270 through image sensor output line 290 to digital processor 292. Digital processor 292 can then analyze the captured image and determine the tip or slope of measurement surface 252. Importantly, during the calibration process, measurement surface 252 is intentionally rotated about measurement point 254 through the entire operational surface-tilt envelope of interferometer 200, said envelope can be up to ±2.0° of rotation about the X and Y axes, or in some examples preferably up to ±5.0° of rotation about the X and Y axes, or ideally more than ±10.0° of rotation about the X and Y axes, while maintaining a substantially constant displacement of measurement surface 252 at measurement spot 254 (or, more particularly, where measurement arm axis 248 intersects measurement surface 252). For every value of intentionally-induced tilt of measurement surface 252 during the calibration process both the determined tip or slope of measurement surface 252 and the determined value of retrace error are stored in memory 296 of digital processor 292. Then, when measuring and determining the topography of an unknown measurement surface 252, which will generally have unknown and/or unanticipated surface tilts or slopes, the amount and direction of surface slope can be determined through the use of the calibration arm as described earlier, the associated retrace error can be recalled from memory 296 of digital processor 292, and the associated retrace error can be subtracted from the value of OPL_{M} determined during the measurement process thereby removing systemic errors caused by imperfections in the optics of interferometer 200 (especially parabolic surface 286). The calibration process described above for removing measurement surface 252 tilt-induced retrace errors from the process of measuring the topography of measurement surface 252 is a key benefit of examples of this technology.

An additional source of measurement error arises from uncertainties in the refractive index of air that interferometer 100 or interferometer 200 resides in. For example, if due to gradients in the temperature, pressure, humidity, or CO₂ levels in the air—that all influence the refractive index of the air—the refractive index of air in the measurement arm is 10⁻⁷ higher than the refractive index of the air of the reference arm, and OPL_{M}≈OPL_{R}=0.1 meter, then a displacement measurement error of 10 nm may occur. To remedy this interferometer 100 or interferometer 200 can be operative in a vacuum, or a soft or partial vacuum, such as less than 0.01 atmosphere, or in some examples preferably less than 0.001 atmosphere, at which level the effects of variations in the refractive index of air due to temperature, pressure, humidity, or CO₂ can have a negligible impact on the accuracy of the displacement measurements made with interferometer 100 or interferometer 200.

Having thus described the basic concept of the invention, it will be rather apparent to those skilled in the art that the foregoing detailed disclosure is intended to be presented by way of example only and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations, such as arrows in the diagrams therefore, is not intended to limit the claimed processes to any order or direction of travel of signals or other data and/or information except as may be specified in the claims. Accordingly, the invention is limited only by the following claims and equivalents thereto.

What is claimed is:

1. An optical interferometer system comprising:
a first parabolic collimator configured to substantially collimate input light on to a collimated light axis;
a beamsplitter configured to split the collimated input light on the collimated light axis into a collimated reference arm light substantially centered on a reference arm axis and collimated measurement arm light substantially centered on the collimated light axis; and
a second parabolic collimator configured to substantially focus the collimated measurement arm light centered on the collimated light axis along a measurement arm axis onto a measurement surface and to substantially collimate at least a portion of the collimated measurement arm light reflected back from the measurement surface;
wherein the beamsplitter is configured to recombine the collimated reference arm light reflected from a reference mirror and the collimated measurement arm light reflected back from the measurement surface and direct the recombined light towards the first parabolic collimator; and
wherein the first parabolic collimator is configured to output the recombined light comprising a measurement of the measurement surface.

2. The system as set forth in claim 1 wherein the beamsplitter comprises a reflective surface with an aperture.

3. The system as set forth in claim 1 wherein a reference arm between the beamsplitter and the reference mirror further comprises an iris substantially centered on the reference arm axis between the beamsplitter and the reference mirror.

4. The system as set forth in claim 1 wherein the optical interferometer is configured to operate with the input light having a wavelength range greater than or equal to 200 nm.

5. The system as set forth in claim 4 wherein the optical interferometer is configured to operate with the input light having a wavelength range greater than or equal to 350 nm.

6. The system as set forth in claim 1 wherein a reference arm between the beamsplitter and the reference mirror has an associated path length and a measurement arm between the second parabolic collimator and the measurement surface has another associated path length and an absolute value of a difference between the associated path length and the another associated path length is greater than 1 micrometers.

7. The system as set forth in claim 6 wherein the absolute value of the difference is less than 10 millimeters.

8. The system as set forth in claim 1 further comprising a fiber optic positioned to provide the input light to the first parabolic collimator and to receive the recombined light, wherein a diameter of an aperture of the fiber optic is less than 6 um.

9. The system as set forth in claim 1 further comprising a calibration arm.

10. The system as set forth in claim 9 wherein the calibration arm further comprises an image sensor.

11. The system as set forth in claim 10 wherein the image sensor comprises a photodetector comprising a plurality of pixels.

12. The system as set forth in claim 9 wherein the calibration arm is further configured to sense a tilt of the measurement surface.

13. The system as set forth in claim 12 further comprising a digital processing system comprising memory having programmed instructions stored thereon and one or more processors configured to execute the stored programmed instructions to: determine a systemic error of the interferometer system based on the sensed tilt of the measurement surface.

14. The system as set forth in claim 13 wherein the processors are further configured to execute the stored programmed instructions to: adjust a measurement of the interferometer system based on the determined systemic error.

15. The system as set forth in claim 1 wherein the interferometer system further comprises a base on which one or more of the beamsplitter, the first parabolic collimator, the second parabolic collimator, or the reference mirror is mounted.

16. The system as set forth in claim 15 wherein the base comprises a material having a CTE less than 1 ppm per degree C.

17. The system as set forth in claim 15 wherein one or more of the beamsplitter, the first parabolic collimator, the second parabolic collimator, or the reference mirror are bonded to the base with a mixture comprising one of at least sodium hydroxide or sodium silicate.

18. A method for making an optical interferometer system, the method comprising:
providing a first parabolic collimator configured to substantially collimate input light on to a collimated light axis;
positioning a beamsplitter to split the collimated input light on the collimated light axis into a collimated reference arm light substantially centered on a reference arm axis and collimated measurement arm light substantially centered on the collimated light axis; and
positioning a second parabolic collimator to substantially focus the collimated measurement arm light centered on the collimated light axis along a measurement arm axis onto a measurement surface and to substantially collimate at least a portion of the collimated measurement arm light reflected back from the measurement surface;
wherein the beamsplitter is configured to recombine the collimated reference arm light reflected from a reference mirror and the collimated measurement arm light reflected back from the measurement surface and direct the recombined light towards the first parabolic collimator; and
wherein the first parabolic collimator is configured to output the recombined light comprising a measurement of the measurement surface.

19. The method as set forth in claim 18 wherein the beamsplitter comprises a reflective surface with an aperture.

20. The method as set forth in claim 18 wherein a reference arm with the reference mirror further comprises an iris substantially centered on the reference arm axis between the beamsplitter and the reference mirror.

21. The method as set forth in claim 18 wherein the optical interferometer is configured to operate with the input light having a wavelength range greater than or equal to 200 nm.

22. The method as set forth in claim 21 wherein the optical interferometer is configured to operate with the input light having a wavelength range greater than or equal to 350 nm.

23. The method as set forth in claim 18 wherein a reference arm between the beamsplitter and the reference mirror has an associated path length and a measurement arm between the second parabolic collimator and the measurement surface has another associated path length and an absolute value of a difference between the associated path length and the another associated path length is greater than 1 micrometers.

24. The method as set forth in claim 23 wherein the absolute value of the difference is less than 10 millimeters.

25. The method as set forth in claim 18 further comprising a fiber optic positioned to provide the input light to the first parabolic collimator and to receive the recombined light, wherein a diameter of an aperture of the fiber optic is less than 6 um.

26. The method as set forth in claim 18 further comprising providing a calibration arm.

27. The method as set forth in claim 26 wherein the calibration arm further comprises an image sensor.

28. The method as set forth in claim 27 wherein the image sensor comprises a photodetector comprising a plurality of pixels.

29. The method as set forth in claim 26 wherein the calibration arm is further configured to sense a tilt of the measurement surface.

30. The method as set forth in claim 29 further comprising a digital processing system comprising memory having programmed instructions stored thereon and one or more processors configured to execute the stored programmed instructions to: determine a systemic error of the interferometer system based on the sensed tilt of the measurement surface.

31. The method as set forth in claim 30 wherein the processors are further configured to execute the stored programmed instructions to: adjust a measurement of the interferometer system based on the determined systemic error.

32. The method as set forth in claim 18 wherein the interferometer system further comprises a base on which one or more of the beamsplitter, the first parabolic collimator, the second parabolic collimator, or the reference mirror is mounted.

33. The method as set forth in claim 32 wherein the base comprises a material having a CTE less than 1 ppm per degree C.

34. The method as set forth in claim 32 wherein one or more of the beamsplitter, the first parabolic collimator, the second parabolic collimator, or the reference mirror are bonded to the base with a mixture comprising one of at least sodium hydroxide or sodium silicate.
